(19) United States
(12) Patent Application Publication
(10) Pub. No.: US 2011/0204632 A1
(43) Pub. Date: Aug. 25, 2011

(54) Synchronous Induced Wind Power Generation System

(76) Inventor: James A. Skala, Hartselle, AL (US)

(21) Appl. No.: 12/713,140

(22) Filed: Feb. 25, 2010

(51) Int. Cl. F03D 7/00; F03D 9/00

(52) U.S. Cl. 290/44

(57) ABSTRACT

A synchronous induced wind power generation system is provided, which is comprised of a rotatable turbine-generator section and a control system operable to rotate same in a direction corresponding to optimal wind conditions. The turbine-generator section has a horizontally disposed turbine therein in an interior area thereof, and orifices formed at either end thereof, with wider areas than the interior area, so as to form a funnel-like shape at either of the turbine-generator section. These funnel-shaped sections optimally funnel wind to the turbine, which is connected to a synchronous generator that runs at synchronous speed with an external power line in connection therewith. Further, turbine brakes are employed to modulate turbine power and speed, and the control system is operable to orient the turbine-generator section with respect to the direction of the wind and generation of power via control of the turbines and synchronous generator, and via receipt of sensor/detector data received from a plurality of sensors/detectors in communication therewith.

### BACKGROUND OF THE INVENTION

1. Field of the Invention

A synchronous induced wind power generation system is provided, which is comprised of a rotatable turbine-generator section and a control system operable to rotate same in a direction corresponding to optimal wind conditions. In particular, a wind power generation system is provided having a turbine-generator section with a horizontally disposed rotating shaft therein connecting the turbine to the generator, orifices formed therein so as to optimally funnel wind over the turbines, turbine brakes to control the rotational speed of the turbines and the shaft power delivered to the generator, and a control system operable to orient the turbine-generator section with respect to the direction of the wind and generation of power via control of the turbine brakes and the synchronous generator.

2. Description of the Related Art

Wind as an alternate motive force for generating electricity has long provided an attractive alternative to conventional power generation techniques. However, the effectiveness of conventional wind power generation systems have been limited by various difficulties such as, for example, the inconsistency of the wind, appropriate locations for placement of wind power generation system far from load centers and the problems of long distance transmission of power, difficulty in repair and maintenance of large systems, etc. These difficulties have inhibited large scale adoption of wind power as an alternate means of energy.

With regards to appropriate locations to place the systems, generally, wind power systems using turbines are developed, built and installed by large power companies, and are generally large units with very long turbine blades. The generator is mounted within a housing or nacelle that is positioned on top of a truss or tubular tower. The turbine blades transform wind energy into a rotational force or torque that drives a generator through a gearbox that steps the speed of the generator up to around 1200 RPM. The generators are DC generators, and produce DC power in proportion to the variable wind speed. The DC power is run through an inverter to get AC power, and the AC power is transmitted to the grid for later sale.

The power companies that install such wind turbines are generally interested only in systems capable of generating large amounts of power. Thus, most current wind turbines use large-sized blades (e.g., 60 meters or more in length). These large size blades result in an economy of scale. However, the longer blades require a supporting tower having a corresponding increased height and size.

Further, such large size blades prevent placement of conventional wind turbines within urban/suburban environments where the greatest demand for energy exists. Moreover, the large wind turbines are more subject to damage from high winds, as well as structural fatigue failures. Namely, the blades are subject to fatigue by encountering significantly higher wind loads at the top of the arc of rotation, followed a second later by lower velocity wind loads, which culminate at the bottom of the arc of rotation by a big thud as the blade passes the supporting column, where the flow of air is disrupted.

To minimize the chance that such conventional wind turbines are damaged by high winds, conventional wind turbines are frequently shut down when winds exceed a predetermined speed. And, the large blades frequently strike birds, resulting in conflict with environmental groups and government regulations.

In view of the deficiencies of conventional wind turbines discussed above, it is an object of the present invention to provide a wind driven electricity generating system that can be run safely and efficiently at 100% load regardless of higher wind speeds, that results in distributed power generation of many small wind generators inside load centers, that do not kill birds, that have no problem with blade failures, and that directly generate synchronous power.

It is a further object of the present invention to provide a wind driven electricity generating system which is structurally unobtrusive so as to be installable in urban/suburban environments close to the source of power consumption, thereby negating the need for expensive and inefficient transmission systems, which is not subject to damage from high winds while remaining at peak generation capacity (rather than shut down for protection), and which is not harmful to wildlife.

### BRIEF SUMMARY OF THE INVENTION

In order to achieve the objects of the present invention, the present inventors endeavored to develop a synchronous induced wind power generation system capable of generating synchronous consistent power regardless of wind velocity or direction, and which may be installed in various locations, including urban and suburban environments. Accordingly, in a first embodiment of the present invention, a synchronous induced wind power generation system comprising:

(a) a turbine-generator section comprised of an outer shell having a first end, a second end opposite the first end, an interior area disposed therebetween, a first orifice disposed at the first end, a second orifice disposed at the second end, a horizontal wind flow axis extending from the first orifice to the second orifice, and an axis of rotation disposed perpendicular to the wind flow axis;

(b) one or more turbine/generator units disposed within the interior area of the turbine-generator section at or between the first orifice and second orifice, each of said turbine/generator units comprised of:
(i) one or more turbine blades disposed in a plane parallel or approximately parallel with the axis of rotation;
(ii) one or more directrix blades disposed in a plane parallel or approximately parallel with the axis of rotation;
(iii) a rotatable shaft having a first end and a second end, the first end of the shaft in connection with the turbine blades;
(iv) a synchronous generator in connection with the second end of the rotatable shaft; and
(v) one or more turbine brakes disposed on or adjacent to the turbine blades;

(c) a direction orientation means in communication with the turbine-generator section at or adjacent to the axis of rotation, said direction orientation means operable to controllably rotate the turbine/generator section about the axis of rotation so as to control the orientation of the turbine-generator section relative to the direction of the wind; and

(d) a control system in conductive communication with each synchronous generator so as to be operable to synchronize the frequency and the voltage phase of the generator with the voltage phase of an external AC power line in conductive communication with the synchronous generator, in conductive or mechanical communication with the direction orientation means so as to be operable to control a position of the turbine/generator section relative to wind direction, and in conductive or mechanical communication with the turbine brakes so as to be operable to control the speed of rotation with no load, or maximum torque during synchronous operation of the turbine, thereby controlling shaft power delivered to the generator, said control system comprised of:
(i) a computer processor;
(ii) one or more of a phase sensor and speed sensor in connection with the computer processor and each of the turbine/generator units;
(iii) one or more of an anemometer and a wind direction detector (wind vane) in communication with the computer processor;
(iv) one or more differential pressure sensors operable to determine fine wind direction in communication with the computer processor.

In a preferred embodiment, the synchronous induced wind power generation of the first embodiment above is provided, wherein the area of the turbine-generator section adjacent the first orifice and the second orifice of larger than the area of the turbine-generator section adjacent the interior area, so as to funnel wind into the turbine-generator section. More preferably, the area of the turbine-generator section adjacent the first orifice and the second orifice is 1.1 to 12 times larger than the area of the turbine-generator section adjacent the interior area. Even more preferably, the area of the turbine-generator section adjacent the first orifice and the second orifice is 5 to 8 times larger than the area of the turbine-generator section adjacent the interior area. Most preferably, the area of the turbine-generator section adjacent the first orifice and the second orifice is about 8 times larger than the area of the turbine-generator section adjacent the interior area.

In a further preferred embodiment, the synchronous induced wind power generation of the first embodiment above is provided, further comprising a computer program product (computer software application) for managing operation of the wind power generation system. This computer program product is comprised of computer usable program code operable to enable the computer processor to communicate with one or more of the various sensors, synchronize frequency and voltage phase of the generator units with the voltage phase of an external power line in communication with the system, monitor and adjust the orientation of the turbine-generator section relative to the wind flow axis, via control of the direction-orientation means. Further, the computer usable program code is operable to control the turbine brakes so as to control and monitor the speed of rotation of the turbine, especially during initial synchronization with the power line and during loss of load, when the load is suddenly removed and the magnetic brakes must supply braking action equivalent to 100% of the generator's output at the instant that the load is lost and attempt to maintain the phase of the line in case the load returns a few seconds later.

In another preferred embodiment, the synchronous induced wind power generation of the first embodiment above is provided, further comprising one or more controllable, pivotable air bypass doors disposed in or adjacent to the first end and second end of the outer shell of the turbine/generator units, which may be operated in such a manner as to reduce excess air flow through the turbine-generator unit.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

FIG. 1 is a perspective view of the synchronous induced wind power generation system of the present invention.

FIG. 2 is a side view of the synchronous induced wind power generation system of the present invention.

FIG. 3 is a partial cross-sectional view of the synchronous induced wind power generation system of the present invention, illustrating the internal configuration of the turbine-generator section having the turbine-generator disposed therein.

FIG. 4 is a partial cross-sectional view of the synchronous induced wind power generation system of the present invention, illustrating one preferred disposition of the turbine-generator unit, turbine brakes relative to the turbines, fixed directrix blading and pivotable air bypass doors within the turbine-generator section.

FIG. 5 is a box diagram illustrating the connectivity of the various components of the control system of the system of the present invention.

### DETAILED DESCRIPTION OF THE INVENTION

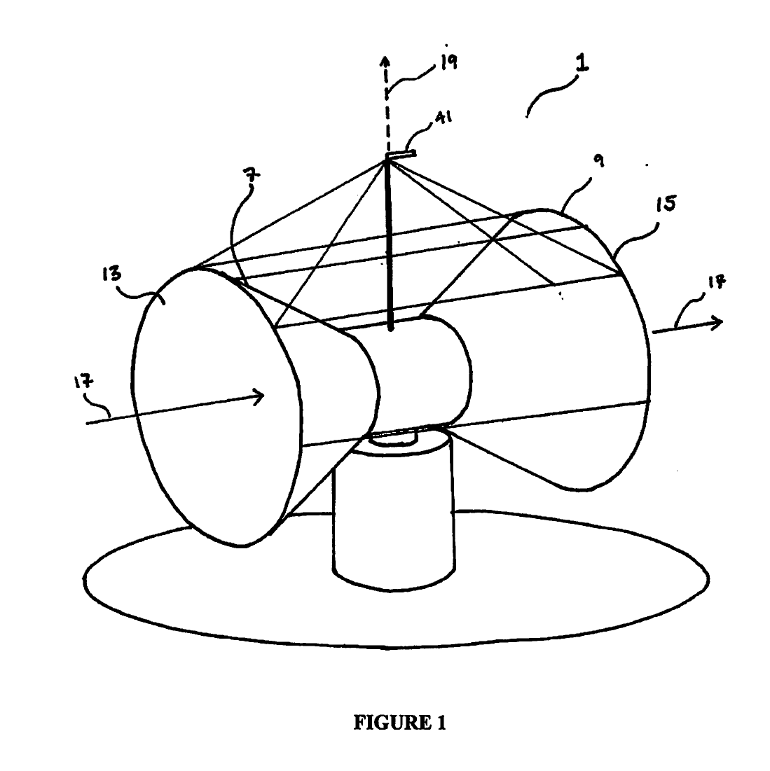

As illustrated in FIGS. 1-3, the present invention provides a synchronous induced wind power generation system 1 comprised generally of a turbine-generator section 3, a turbine-generator unit 21 disposed therein, a direction orientation means 45 in movable connection with the turbine-generator section 3, and a control system 33 operable to control the entire system 1 based on, for example, wind velocity, wind direction, external load characteristics, power requirements, etc.

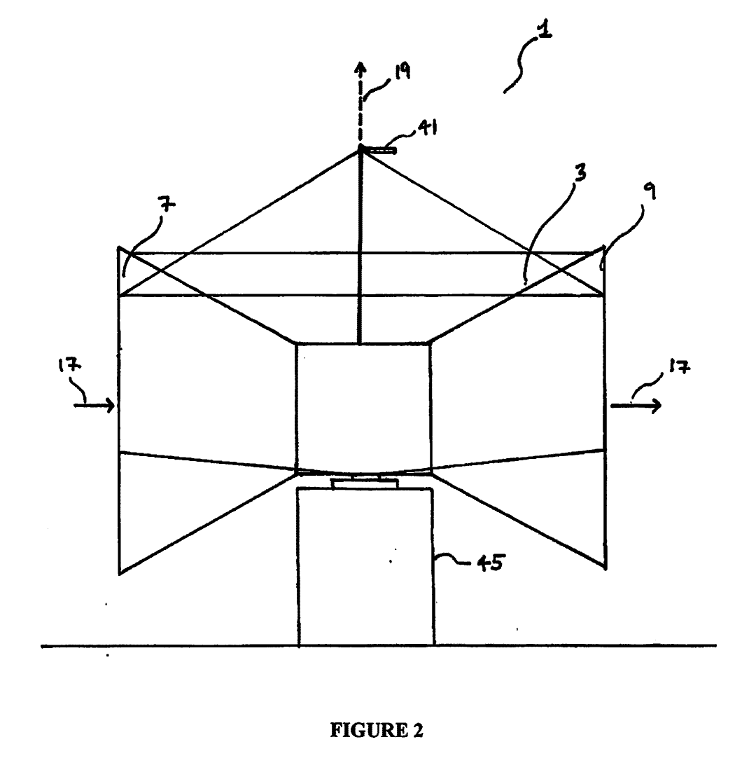

Specifically, as shown in FIGS. 1 and 2, the turbine-generator section 3 is comprised of an outer shell 5 having a first end 7, a second end 9 opposite the first end 7, and an interior area 11 disposed there between. A first orifice 13 is disposed at the first end 7, a second orifice 15 is disposed at the second end 9, a wind flow axis 17 extends from the first orifice 13 to the second orifice, and an axis of rotation 19 disposed perpendicular to the wind flow axis 17. The turbine-generator section 3 may be formed in any shape, such as conical, square or rectangular shape, a variation thereof, as well as two or more of same.

In a preferred embodiment, as illustrated in FIGS. 1 and 2, the area of the turbine-generator section 3 adjacent the first orifice 13 and the second orifice 15 are larger than the area of the turbine-generator section 3 adjacent the interior area 11 so as to funnel wind into the turbine-generator section, thereby increasing wind flow through the turbine-generator section 3 and allowing power generation in relatively light wind velocity. Preferably, the area of the turbine-generator section adjacent the first orifice 13 and the second orifice 15 is 1.1 to 12 times larger than the area of the turbine-generator section 3 adjacent the interior area 11, more preferably, 5 to 8 times larger than the area of the turbine-generator section 3 adjacent the interior area 11, most preferably about 8 times larger than the area of the turbine-generator section 3 adjacent the interior area 11.

By forming the turbine-generator section with orifices having a wider diameter (area) than the interior area 11 of section 3, two coaxial “funnels” are formed. Thus, wind that is blowing horizontal to the ground can blow through one end of the turbine-generator section 3 and exit out the other end. The exit end induces a negative pressure from the wind blowing past it. The upwind end forms a positive pressure from the wind blowing against it. The differential pressure between the two causes a substantial increase in wind velocity through the interior area 11 of the turbine-generator section 3, and hence an increased wind velocity over the turbine blades 23 disposed therein.

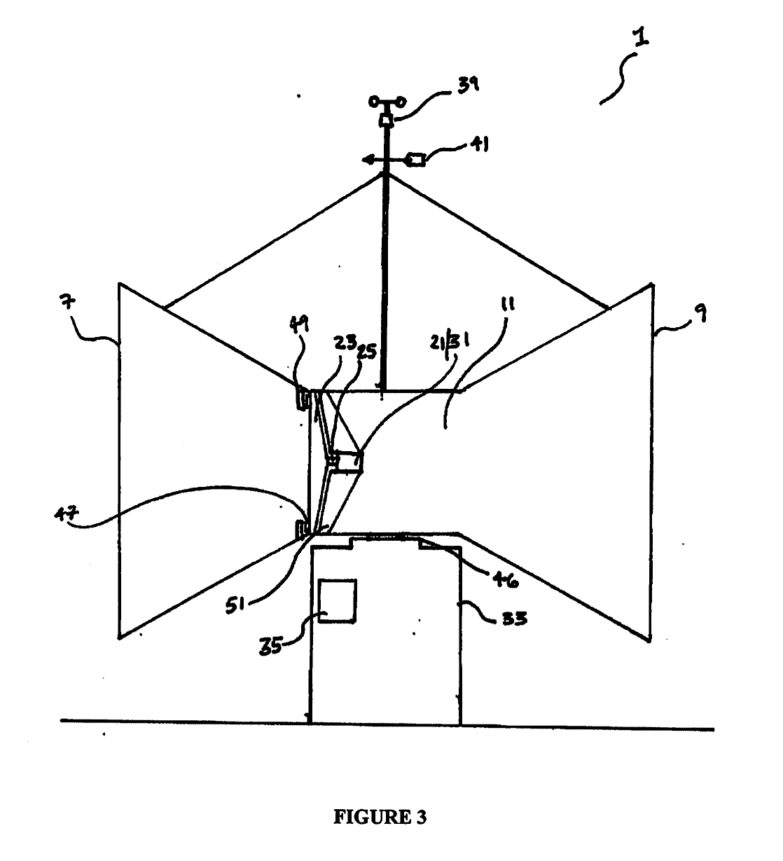

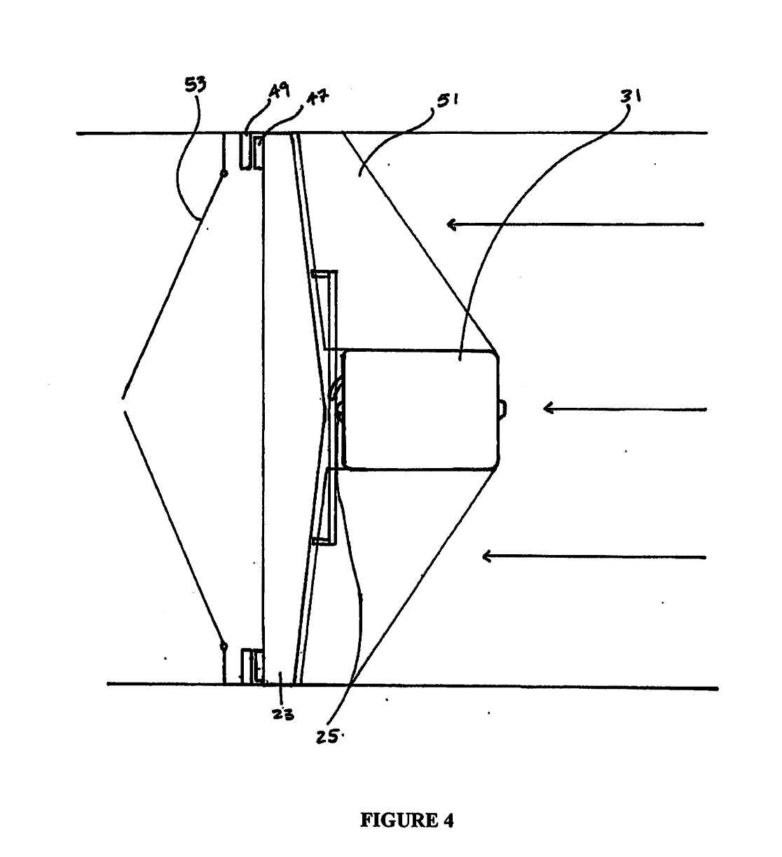

Specifically, as shown in FIGS. 3 and 4, the turbine/generator unit(s) 21 is disposed within the interior area 11 of the turbine-generator section 3 at or between the first orifice 13 and the second orifice 15. The turbine/generator unit(s) 13 is comprised of one or more turbine blades 23, a rotatable shaft 25 in connection therewith, and a synchronous generator 31 in connection with the rotatable shaft 25 opposite the turbine blades 23. Preferably, the turbine blades 23 are disposed in a plane parallel or approximately parallel with the axis of rotation 19.

As illustrated in 4, one or more turbine brakes are disposed on or adjacent to the turbine blades. The turbine brakes, which are in communication with the control system 33 so as be operated thereby, are comprised of metallic brake discs 47 and turbine brake electromagnets 49 operable to induce magnetic lines of flux perpendicular to the horizontal axis of the metallic brake discs 47, so as to induce braking action in the metallic brake discs. This orientation allows precise control of the turbine velocity without use of high maintenance, moving parts. Further, the turbine brakes, which are in conductive or mechanical communication with the control system 33, are used to control the speed of rotation with no load, or torque during synchronous operation of the turbine generator unit 21, thereby controlling shaft power delivered to the synchronous generator 31.

To maximize power generation, the wind flow axis 17 of the turbine-generator section 3 should be brought into an approximately parallel orientation with respect to current wind flow. If wind speed increases turbine shaft power above 100% and below about 150% of the generator's power rating, the magnetic brakes are employed to keep the generator at 100% loading. If the wind speed increases turbine power above about 150% of the generator's power rating, the pivotable air bypass doors 53 can be opened as needed to keep turbine power around 150%, with the magnetic brakes absorbing the excess power above 100% of the generator's power rating.

Further, if wind speed increases to a level capable of damaging the turbine-generator unit, a means for rotating the turbine-generator section 3 away from the wind to decrease air flow through the turbine-generator section 3 is desirable. To provide such a means, a direction orientation means 45, as shown in FIGS. 1-3, is provided in communication with the turbine-generator section 3 at or adjacent to the axis of rotation 19. The direction orientation means 45 is operable to controllably rotate the entire turbine/generator section 3 about the axis of rotation 19, so as to control the orientation of the turbine-generator section relative to the direction of the wind.

The direction orientation means 45 may be comprised of any conventional means of rotating a structure about an axis. In a preferred embodiment, the direction orientation means 45 is comprised of an electric, pneumatic or hydraulic motor in connection with shaft. As illustrated in FIGS. 1 and 2, the shaft 46 has a first end and a second end, the first end of the shaft 46 being in rotatable communication with the motor means 48, and the second end of the shaft 46 being affixed to the turbine-generator section 3. The motor means 48 is in communication, via one or more of a conductive, mechanical or fluid connection, depending on the type of motor used, with the control system 33, such that the control system may actuate the motor means so as to rotate the turbine-generation section 3 to a desired position with respect to wind flow.

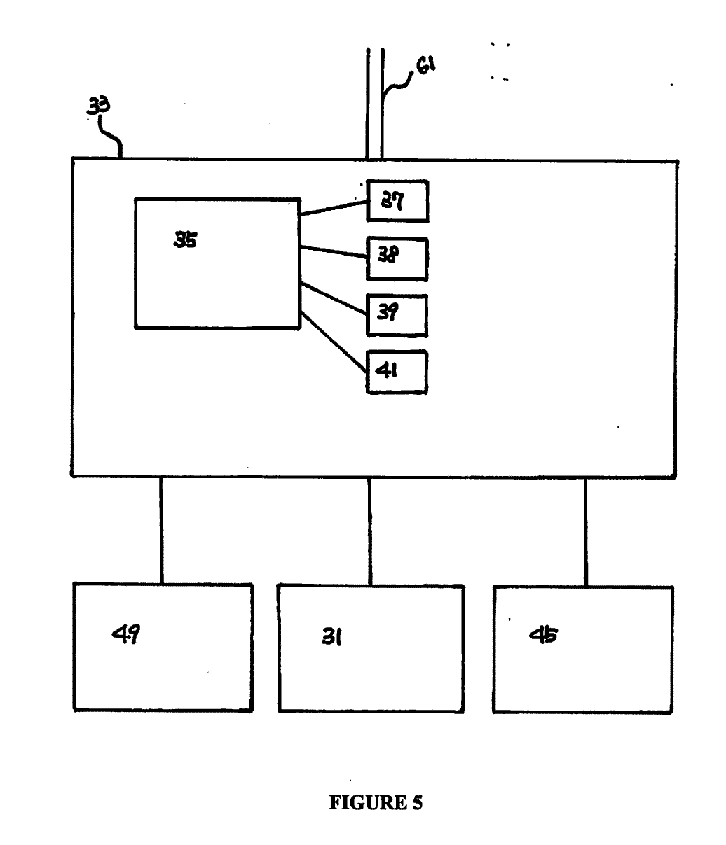

As mentioned above, and as illustrated in FIGS. 3 and 5, a control system 33 is provided in conductive communication with each synchronous generator 31 so as to be operable to synchronize the frequency and the voltage phase of the generator with the voltage phase of an external AC power line 61 in conductive communication with the synchronous generator. In a preferred embodiment, a voltage regulator 63 is provided in communication with the computer processor. Preferably, the wind turbines are set to rotate at a one fixed (predetermined) speed when generating electrical power. This one fixed operating speed is mainly dependent on turbine diameter. The fixed turbine operating speed determines the number of poles required for the generator to produce 60 hertz power. For example, a 450 RPM turbine requires a 16-pole synchronous generator to produce 60 hertz power, and the 450 RPM speed equates to a turbine tip speed of 471 feet per second for a 10-foot diameter turbine, which facilitates the operation of the magnetic brakes.

The ability to choose a generator to match the speed of the turbine desirably allows for direct drive, rather than a geared drive, thereby simplifying the design and minimizing the cost of construction. The turbine is designed to optimize energy transfer at some fixed speed. The synchronous generator 31 runs synchronized with the power line when operating, and generates 60 hertz AC power (for US applications) at any power factor desired, such that the AC output voltage can be regulated by controlling the field current in the generators. Thus, the synchronous generator 31 of the present invention can produce VARS to create any Power Factor within the operating range of the generator.

During start-up, the magnetic brakes are used to absorb all turbine power until about 10% power is achieved while holding the turbine speed at approximately the synchronous speed of the generator. Then, the exciter is energized to cause AC voltage output of the generator to match the voltage of the outside electrical grid (via an external AC line). The magnetic brakes are used to adjust the phase of the generator to the phase of the line, then the unit breaker is closed to connect the synchronous generator 31 to the power grid. The magnetic brakes are then released, allowing the 10% or so power that was being absorbed by the magnetic brakes to reach the generator. If the generator power falls below about 1%, the unit breaker is opened and the magnetic brakes resume controlling the maximum speed of the turbine.

The control system 33 is comprised of a computer processor 35. The computer processor 35 may be any conventional computer, such as a desktop computer, a laptop computer, or any computing mechanism that performs operations via a microprocessor, which is a programmable digital electronic component that incorporates the functions of a central processing unit (CPU) on a single semi-conducting integrated circuit (IC). One or more microprocessors typically serve as the CPU in a computer system, embedded system, or handheld device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The control system 33 is further comprised of one or more of a phase sensor 37 and speed sensor 38, both of which are in connection with the computer processor 35 and each of the synchronous generators 31. The phase sensor 37 and speed sensor 38 are preferably one or more of an optical sensor, mechanical sensor, or magnetic sensor. Further, as illustrated in FIGS. 1 and 2, one or more of an anemometer 39 and a wind direction detector (wind vane) 41 is provided in communication with the computer processor 35. In addition, in a preferred embodiment, one or more differential pressure sensors 65 is provided in communication with the computer processor 35 to determine fine wind direction.

The anemometer 39 and a wind direction detector (wind vane) 41 are preferably disposed on or adjacent to the turbine-generator section 3. The phase sensor 37, which is operable to sense the phase and speed of rotation of the shaft 25, is disposed on, adjacent to, or in connection with the rotatable shaft 25 of each of the turbine-generator units 21, said phase sensor. Data is recorded by each of these sensors/detectors, and fed to the computer processor 35 for use/analysis by the control system 33 in determining proper operating parameters of the system 1.

As illustrated in FIG. 4, in a preferred embodiment, two or more fixed directrix blades 51 are disposed adjacent to and upwind of the wind turbine 21 at one end thereof, and attached to the turbine-generator section 3 at an opposite end thereof, and may also support the turbine generator unit 21 within the interior area 11 of the turbine-generator section 3. However, the fixed directrix blading, which perform the function of directing air flow and/or supporting the integrity of the turbine-generator section 3, may be alternately or additionally disposed forward of the turbine blades 23, between the blades 23 and first orifice 13, or rearward of the blades 23, between synchronous generator 31 and the second orifice 15. Further, alternatively, the fixed directrix blades 51 may be disposed in the orifices 13 and 15.

In a further preferred embodiment, as illustrated in FIG. 4, one or more pivotable air bypass doors 53, as mentioned above, are disposed in or adjacent to the first end 7 and/or second end 9 of the outer shell 5 of the turbine/generator section 3. These doors 53, which are in communication with the control system 33 via mechanical, electrical or hydraulic means, may be opened proportionally to shunt air around the wind turbine during high ambient wind conditions. In particular, when the control system 33 determines that air flow through the turbine-generator section 3 has exceeded a predetermined desirable level, the pivotable air bypass doors 53 may be fully or partially opened to limit excess air flow through the turbine-generator unit 21.

The synchronous induced wind power generation system 1 of the present invention further comprises a computer program product for managing operation of the wind power generation system, and method of operating the wind power generation system via use of same. The computer program product is stored on a computer-usable or computer readable medium which may be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, a removable FLASH memory medium, a random access memory (RAM), a read-only memory (ROM), a rigid magnetic disk and an optical disk. Current examples of optical disks include compact disk—read only memory (CD-ROM), compact disk—read/write (CD-R/W) and DVD.

The computer usable medium has computer usable program code embodied thereon, the computer usable program code comprising various code operable to control the operation of the system 1. In particular, in a first embodiment, the computer usable program code is operable to enable the computer processor to communicate with one or more of the anemometer, wind direction detector, differential pressure sensor, and phase sensors, so as to receive and store data therefrom. Further, computer usable program code is operable to enable the control system 33 to synchronize frequency and voltage phase of the synchronous generator 31 with the voltage phase of an external AC power line 61 in communication with the system 1.

In a further preferred embodiment, the computer program of the present invention is further operable to control the magnetic brakes to modulate shaft power delivered to the generator(s) units during wind transients, so as to prevent instantaneous overloads of the generator units, to control the speed of the generator units during loss of external electrical load of the generator units via application of the magnetic brakes and rotation of the turbine/generator section relative to the direction of the wind, to control voltage of the generator units during normal operation and at a moment of loss of external electrical load of the generator units, and to monitor and redirect mechanical loads of greater than 150% of full generator power from the wind turbines after loss of external electrical load of the generator units to the generator units as shaft power, so as to maintain the turbines at full speed until the external electrical load is restored, thereby allowing the generator to recover full power after short line load interruptions in very short time periods.

Thus, the computer program product provide the following general functionality:

(1) communication of the computer processor with one or more of the various sensors;

(2) synchronization of the frequency and voltage phase of the generator units with the voltage phase of an external power line in communication with the system;

(3) monitoring and adjustment of the orientation of the turbine-generator section relative to the wind flow axis, via computer control of the direction-orientation means; and

(4) electrical control of the turbine brakes so as to control and monitor the speed of rotation of the turbine.

Further, the computer program is operable to monitor and adjust the orientation of the turbine-generator section relative to the wind flow axis, via control of the direction-orientation means, so as to maintain a maximum amount of air flow through the turbine-generator section. In addition, as mentioned above, the computer usable program code is operable to enable the control system 33 to control operation of the turbine brakes.

In another preferred embodiment, computer program is also operable to enable the control system 33 to control operation (opening and closing) of the pivotable air bypass doors 53.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

### LIST OF DRAWING ELEMENTS

1: synchronous induced wind power generation system
3: turbine-generator section
5: outer shell of turbine-generator section
7: first end of turbine-generator section
9: second end of turbine-generator section
11: interior area of turbine-generator section
13: first orifice
15: second orifice
17: wind flow axis
19: axis or rotation
21: turbine/generator unit
23: turbine blades
25: rotatable shaft
31: synchronous generator
33: control system
35: computer processor
37: phase sensor
38: speed sensor
39: anemometer
41: wind direction detector (wind vane)
45: direction orientation means
46: shaft of direction orientation means
47: metallic brake discs
48: motor means
49: turbine brake electromagnets
51: fixed directrix blade
53: pivotable air bypass door
61: external AC line
63: voltage regulator
65: differential pressure sensor

What is claimed is:

1. A synchronous induced wind power generation system comprising:
(a) a turbine-generator section comprised of an outer shell having a first end, a second end opposite the first end, an interior area disposed therebetween, a first orifice disposed at the first end, a second orifice disposed at the second end, a wind flow axis extending from the first orifice to the second orifice, and an axis of rotation disposed perpendicular to the wind flow axis;
(b) one or more turbine/generator units disposed within the interior area of the turbine-generator section at or between the first orifice and second orifice, each of said turbine/generator units comprised of
(i) one or more turbine blades disposed in a plane parallel or approximately parallel with the axis of rotation;
(ii) a rotatable shaft having a first end and a second end, the first end of the shaft in connection with the turbine blades;
(iii) a synchronous generator in connection with the second end of the rotatable shaft; and
(iv) one or more turbine brakes disposed on or adjacent to the turbine blades;
(c) a direction orientation means in communication with the turbine-generator section at or adjacent to the axis of rotation, said direction orientation means operable to controllably rotate the turbine/generator section about the axis of rotation so as to control the orientation of the turbine-generator section relative to the direction of the wind; and
(d) a control system in conductive communication with each synchronous generator so as to be operable to synchronize the frequency and the voltage phase of the generator with the voltage phase of an external AC power line in conductive communication with the synchronous generator, in conductive or mechanical communication with the direction orientation means so as to be operable to control a position of the turbine/generator section relative to wind direction, and in conductive or mechanical communication with the turbine brakes so as to be operable to control the speed of rotation with no load, or torque during synchronous operation of the turbine, thereby controlling shaft power delivered to the generator, said control system comprised of:
(i) a computer processor;
(ii) one or more of a phase sensor and speed sensor in connection with the computer processor and each of the turbine/generator units;
(iii) one or more of an anemometer and a wind direction detector (wind vane) in communication with the computer processor; and
(iv) one or more differential pressure sensors operable to determine fine wind direction in communication with the computer processor.

2. The synchronous induced wind power generation system of claim 1, wherein the area of the turbine-generator section adjacent the first orifice and the second orifice of larger than the area of the turbine-generator section adjacent the interior area.

3. The synchronous induced wind power generation system of claim 2, wherein the area of the turbine-generator section adjacent the first orifice and the second orifice is 1.1 to 12 times larger than the area of the turbine-generator section adjacent the interior area.

4. The synchronous induced wind power generation system of claim 2, wherein the area of the turbine-generator section adjacent the first orifice and the second orifice is 5 to 8 times larger than the area of the turbine-generator section adjacent the interior area.

5. The synchronous induced wind power generation system of claim 2, wherein the area of the turbine-generator section adjacent the first orifice and the second orifice is about 8 times larger than the area of the turbine-generator section adjacent the interior area.

6. The synchronous induced wind power generation system of claim 1, wherein the direction orientation means is comprised of:
(a) an electric, pneumatic or hydraulic motor means; and
(b) a shaft having a first end and a second end, the first end of the shaft being in rotatable communication with the motor means, and the second end of the shaft being affixed to the turbine-generator section.

7. The synchronous induced wind power generation system of claim 1, wherein the one or more of an anemometer and a wind direction detector (wind vane) are disposed on or adjacent to the turbine-generator section.

8. The synchronous induced wind power generation system of claim 1, wherein the phase sensor is disposed on, adjacent to, or in connection with the rotatable shaft of each of the turbine/generator units, said phase sensor operable to sense the phase and speed of rotation of the shaft.

9. The synchronous induced wind power generation system of claim 1, wherein the speed and phase sensor is comprised of one or more of an optical sensor, mechanical sensor, or magnetic sensor.

10. The synchronous induced wind power generation system of claim 1, wherein the turbine brakes are magnetic brakes comprised of
(i) one or more metallic brake discs disposed on or in connection with the turbines, so as to rotate therewith; and
(ii) one or more electromagnets statically disposed adjacent to the metallic brakes, and in conductive communication with the computer processor, said electromagnets operable to induce magnetic lines of flux perpendicular to the horizontal axis of the metallic brake discs, so as to induce braking action in the metallic brake discs

11. The synchronous induced wind power generation system of claim 1, further comprising:
two or more fixed directrix blades disposed adjacent to and in communication each of the turbine generator units at one end thereof, and attached to the turbine-generator section at an opposite end thereof, so as to support the turbine generator units within the interior area of the turbine-generator section.

12. The synchronous induced wind power generation system of claim 1, further comprising:
one or more pivotable air bypass doors in communication with the control system, and disposed in or adjacent to the first end and second end of the outer shell of the turbine/generator units adjacent the turbine blades,
wherein said pivotable air bypass doors are operable to reduce excess air flow through the turbine-generator unit.

13. The synchronous induced wind power generation system of claim 1, further comprising a voltage regulator in communication with the computer processor.

14. The synchronous induced wind power generation system of claim 1, further comprising a computer program product for managing operation of the wind power generation system, the computer program product comprising:
a computer usable medium having computer usable program code embodied therewith, the computer usable program code comprising:
(a) computer usable program code operable to enable the computer processor to communicate with one or more of the anemometer, wind direction detector, differential pressure sensor, and phase sensor;
(b) computer usable program code operable to synchronize frequency and voltage phase of the generator units with the voltage phase of an external power line in communication with the system;
(c) computer usable program code operable to monitor and adjust the orientation of the turbine-generator section relative to the wind flow axis, via control of the direction-orientation means, so as to maintain a predetermined amount of air flow through the turbine-generator section; and
(d) computer usable program code operable to enable control of the turbine brakes.

15. The synchronous induced wind power generation system of claim 14, wherein the computer program product further comprises:
computer usable program code operable to enable control of the pivotable air bypass doors.

16. The synchronous induced wind power generation system of claim 14, wherein the computer usable program code further comprises:
(e) computer usable program code operable to control the magnetic brakes to modulate shaft power delivered to the generator(s) units during wind transients, so as to prevent instantaneous overloads of the generator units;
(f) computer usable program code operable to control the speed of the generator units during loss of external electrical load of the generator units via application of the magnetic brakes and rotation of the turbine/generator section relative to the direction of the wind;
(g) computer usable program code operable to control voltage of the generator units during normal operation and at a moment of loss of external electrical load of the generator units; and
(h) computer usable program code operable to monitor and redirect mechanical loads of greater than 100% of full generator power from the wind turbines after loss of external electrical load of the generator units to the generator units as shaft power, so as to maintain the turbines at full speed until the external electrical load is restored, thereby allowing the generator to recover short line load interruptions in very short time periods.

17. The synchronous induced wind power generation system of claim 1, wherein the synchronous generator runs at a fixed speed so as to produce an AC output synchronous with the power line voltage.
